(19) United States
(12) Patent Application Publication
(10) Pub. No.: US 2008/0077845 A1
(43) Pub. Date: Mar. 27, 2008

(54) GRAPHIC USER INTERFACE CAPABLE OF COLLECTIVELY AND SELECTIVELY CHANGING INSTANCES USING MASTER AND METHOD OF COLLECTIVELY AND SELECTIVELY CHANGING INSTANCES USING MASTER

(75) Inventors: Soo-ho Cho, Seoul (KR); Deok-won Kim, Incheon (KR); Ju-youn Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/777,755

(22) Filed: Jul. 13, 2007

(30) Foreign Application Priority Data
Sep. 27, 2006 (KR) 1020060094296

(51) Int. Cl. G06F 15/00

(52) U.S. Cl. 715/205

(57) ABSTRACT

Provided are a graphic user interface capable of collectively and selectively changing instances using a master and a method of collectively and selectively changing instances using a master. A graphic user interface capable of collectively changing instances using a master according to an exemplary embodiment of the invention includes: a master area having masters, which are objects to be copied, defined therein; and a text editing area capable of copying the master to draw up a document. In the graphic user interface, the master area is formed in a hierarchy structure of child masters and a parent master made by combining the child masters. When a specific child master in the master area is changed, the child masters constituting the parent master that includes the specific child master are changed, and the child masters before the change and the instances linked to the text editing area by the parent master are all changed.

### CROSS REFERENCE TO RELATED APPLICATION

This application claims priority from Korean Patent Application No. 10-2006-0094296 filed on Sep. 27, 2006 in the Korean Intellectual Property Office, the disclosure of which is incorporated herein by reference in its entirety.

### BACKGROUND OF THE INVENTION

1. Field of the Invention

Methods and apparatuses consistent with the present invention relate to a graphic user interface capable of collectively and selectively changing instances using a master and a method of collectively and selectively changing instances using a master, and more particularly, to a graphic user interface capable of collectively and selectively changing instances using a master and a method of collectively and selectively changing instances using a master in which, when child masters are changed in a hierarchy structure of the child masters and a parent master, the parent master is also changed and the link between the masters and the instances are controlled to selectively change the instances.

2. Description of the Related Art

In general word processors, it is possible to collectively change character strings by using a batch change function, but it is difficult to collectively change objects, such as pictures and figures. In MS VISIO, which is a word processor, a master is used to collectively change objects, such as pictures and figures.

In MS VISIO, when a master, which is an object to be copied, is changed, instances that are copied to a text editing window by the master and are linked to the master are collectively changed.

However, it is difficult to selectively change some of the instances linked to the master. If a user wants to unlink the master from the instances, the user should delete the master. However, in this case, it is difficult to unlink the master from some of the instances, but the master is unlinked from all the instances, which makes it difficult to change some of the instances.

In a case in which masters having child masters and a parent master made by combining the child masters are formed in a hierarchy structure, generally, when a user changes the child master, the user expects the child masters constituting the parent master to be changed. However, in the related art, in the hierarchy structure of masters, when the child master is changed, the change in the child master has no effect on the parent master since the child master is independent of the parent master. As a result, only the instances that are copied from the child masters and are linked to the child masters are changed.

### SUMMARY OF THE INVENTION

The present invention provides a graphic user interface and a method for collectively changing parent masters when child masters are changed in a hierarchy structure of a master including the parent master and the child masters.

The present invention also provides a graphic user interface and a method for controlling the link between a master and instances to selectively change the instances.

According to an aspect of the present invention, there is provided a graphic user interface capable of collectively changing instances using a master, the graphic user interface including: a master area having masters, which are objects to be copied, defined therein; and a text editing area capable of copying the master to draw up a document. In the graphic user interface, the master area is formed in a hierarchy structure of child masters and a parent master made by combing of the child masters. When a specific child master in the master area is changed, the child masters constituting the parent master that includes the specific child master are changed, and the child masters before the change and the instances linked to the text editing area by the parent master are all changed.

According to another aspect of the present invention, there is provided a graphic user interface capable of selectively changing instances using a master, the graphic user interface including: a master area having masters, which are objects to be copied, defined therein; and a text editing area capable of drawing up a document and including the instances that are copied from the masters and are linked to the masters. In the graphic user interface, when the master in the master area is changed, the instances are selectively changed.

According to still another aspect of the present invention, there is provided a method of collectively changing instances using a master in a word processor including a master window having masters, which are objects to be copied, defined therein and a text editing window copying the masters to draw up a document, the master window being formed in a hierarchy structure of child masters and a parent master made by combining the child masters, the method including: changing a specific child master in the master window; select whether to change the child masters constituting the parent master that includes the specific child master; when it is selected to change the child masters, the child masters constituting the parent master are changed, and the child masters before the change and the instances generated by the parent masters are all changed; and when it is selected not to change the child masters, only the instances generated by the child masters before the change are changed.

According to yet another aspect of the present invention, there is provided a method of selectively changing instances using a master in a word processor including a master window having masters, which are objects to be copied, defined therein and a text editing window capable of drawing up a document and including the instances that are copied from the masters and are linked to the masters, the method including: changing a specific master in the master window; selecting the instance not to be changed among the instances linked to the specific master; and changing only the instances other than the selected instance.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating the structure of a graphic user interface according to an exemplary embodiment of the invention;

FIG. 2 is a diagram illustrating a word processor according to an exemplary embodiment of the invention;

FIG. 3 is an enlarged view of a portion A of FIG. 2, which is a master area;

FIG. 4 is a diagram illustrating a process of generating a parent master by combining child masters according to an exemplary embodiment of the invention;

FIG. 5 is a diagram illustrating a master structure view area according to an exemplary embodiment of the invention;

FIG. 6 is a diagram illustrating a hierarchy structure of a parent master and child masters according to an exemplary embodiment of the invention;

FIGS. 7A and 7B are diagrams illustrating a collective change in parent masters due to a change in a child master in a word processor capable of collectively changing instances using a master according to an exemplary embodiment of the invention;

FIG. 8 is a diagram illustrating a master changing area according to an exemplary embodiment of the invention;

FIGS. 9A and 9B are diagrams illustrating a case in which masters are unlinked from instances and the instances are selectively changed when the masters are changed in a word processor capable of selectively changing the instances using the masters according to an exemplary embodiment of the invention;

FIG. 10 is a flow chart illustrating a method of collectively changing instances using a master according to an exemplary embodiment of the invention; and

FIG. 11 is a flow chart illustrating a method of selectively changing instances using a master according to an exemplary embodiment of the invention.

### DETAILED DESCRIPTION OF THE EXEMPLARY EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

A graphic user interface capable of simultaneously or selectively changing instances using a master and a method of collectively or selectively changing instances using a master according to an exemplary embodiment of the invention will be described below with reference to the accompanying drawings.

First, a word processor capable of collectively changing instances using a master according to an exemplary embodiment of the invention will be described below.

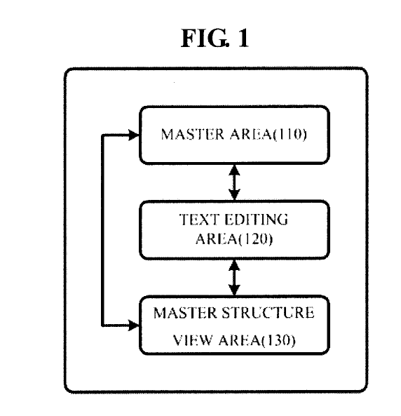

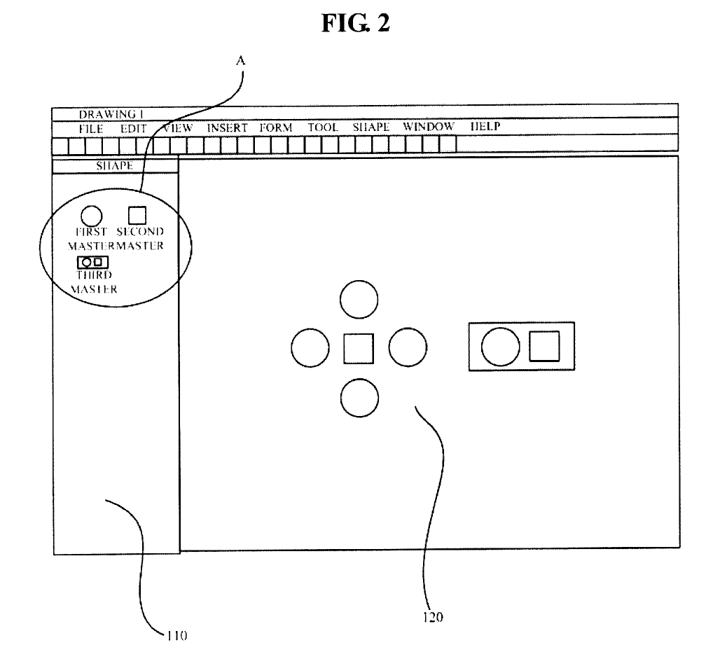

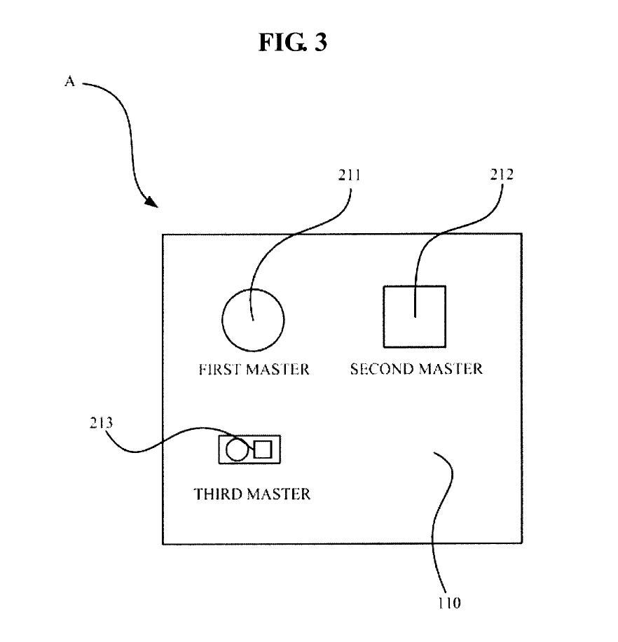

FIG. 1 is a block diagram illustrating the structure of a graphic user interface (GUI) according to an exemplary embodiment of the invention. FIG. 2 is a diagram illustrating a word processor according to an exemplary embodiment of the invention. FIG. 3 is an enlarged view of a portion A of FIG. 2, which is a master area.

A word processor capable of collectively changing instances using a master according to an exemplary embodiment of the invention may include a master area 110 and a text editing area 120.

The word processor further includes a master structure view area 130.

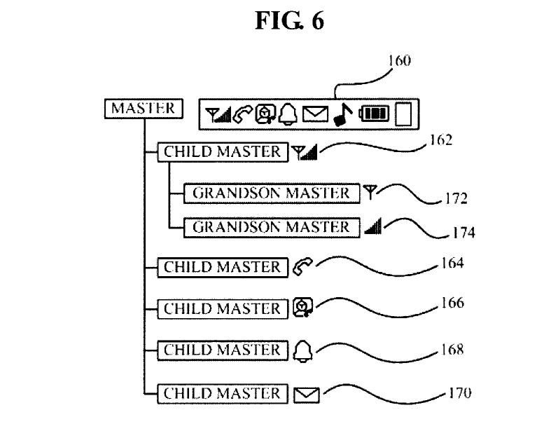

The master area 110 defines masters 211, 212, and 213, which are copied objects. The master may be an object, such as a figure, a photograph, a picture, or text. The masters defined in the master area 110 may be copied to the text editing area 120, which will be described later. Referring to FIG. 3, the master area 110 has three masters 211, 213, and 214 registered therein. For example, icons of the first master 211 indicating a circle, the second master 212 indicating a rectangle, and the third master 213 made by combining the first master 211 with the second master 212 are registered in the master area 110. The first master 211 and the second master 212 are child masters of the third master 213, which is a combination of the first master 211 and the second master 212, and the third master 213 is a parent master of the first master 211 and the second master 212. When the third master 213 is combined with another master to form a new master, it goes without saying that the third master 213 will be a child master of the new master. The hierarchy structure of the masters will be described with reference to FIG. 6.

A master may be selected from the master area 110 (for example, by a double click of a mouse) to generate a master changing area 410, which will be described later.

The test editing area 120 is an area used to emit text and corresponds to an editing window of a general word process. A user can edit text in the test editing area 120 at will. The user can copy the master registered in the master area 110 and use the copied master in the text editing area 120. The object copied to the text editing area 120 by the master is called an instance. The instance has a link to the master, and thus the attribute of the master is shared with the instance. Therefore, when the size or color of the master is changed or when the master is substituted for another object, the instance is automatically changed according to the change in the master.

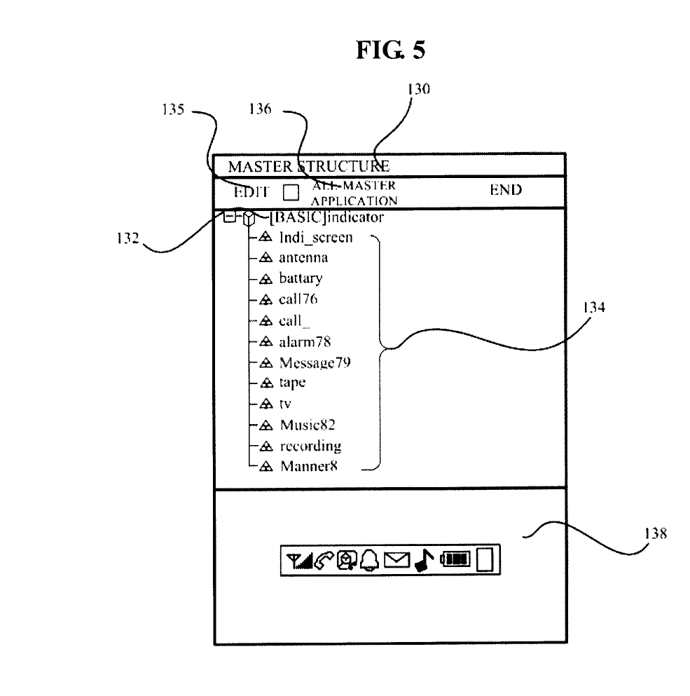

The master structure view area 130 shows the hierarchy structure of the masters to the user so that the user can intuitively check the hierarchy structure. Preferably, but not necessarily, the master structure view area 130 shows the hierarchy relationship between the parent master and the child master in the form of a tree structure. A detailed description thereof will be made with reference to FIG. 5.

When one of the masters shown in the master structure view area 130 is selected (for example, by double-clicking on the master via a mouse or by selecting the master and clicking a specific button), it is possible to form the master changing area 410 for changing the selected master.

When the parent master and the child master exist in the master structure view area 130, the user can unlink the parent master from the child master or link the parent master to the child master again in the master structure view area 130. As described above, the link relationship sharing the attribute is established between the instance and the master. However, in this exemplary embodiment of the invention, the link relationship may be established between the parent master and the child master. When the child master is changed, the child master constituting the parent master may also be changed in the parent master. In this case, when the parent master is unlinked from the child master, the parent master is not changed although the child master is changed. Therefore, it is possible to easily unlink the parent master from the child master in the master structure view area 130.

A method of using a master to generate an instance in the text editing area 120 is the same as the related art. When a user uses an input device, such as a mouse, to drag and drop an icon registered in the master area 110 into the text editing area 120, the user may generate an instance in the text editing area 120. The user may copy a master and paste the copied master in the text editing area 120 to generate an instance.

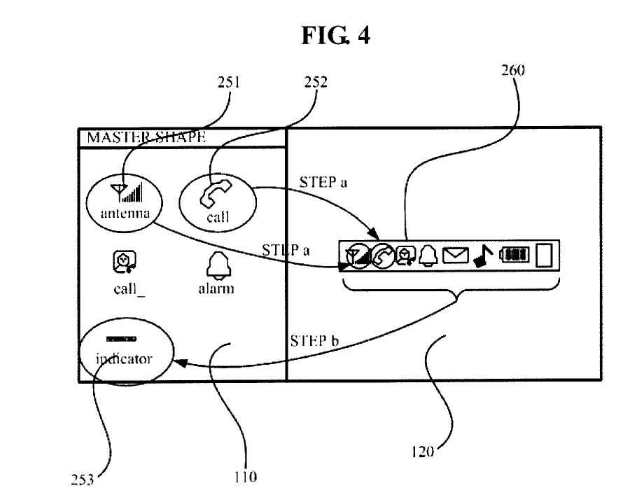

FIG. 4 is a diagram illustrating a process of combining child masters to generate a parent master according to an exemplary embodiment of the invention.

Next, a method of generating a new master by using a master and forming a hierarchy structure will be described. As shown in FIG. 4, masters 251 and 252 having names “antenna” and “call” that represent indicators of a cellular phone are formed in the master area 110. First, instances are generated in the text editing area 120 by the above-mentioned method using the child masters 251 and 252 constituting a new parent master 253 (step a). The generated instances are appropriately arranged in a group to generate an object 260, and the object 260 is dragged and dropped in the master area 110, thereby generating a new parent master 253 (step b).

In this case, it is not necessarily to form a group of instances by using a rectangular box, as shown in FIG. 4. For example, the instances generated by the child masters 251 and 252 are appropriately arranged and selected, and are then dragged and dropped to generate a parent master.

FIG. 5 is a diagram illustrating a master structure view area according to an exemplary embodiment of the invention, and FIG. 6 is a diagram illustrating the hierarchy structure of the parent master and the child masters according to an exemplary embodiment of the invention.

In FIG. 6 showing the hierarchy structure of the parent master and the child masters, a new master may be generated by combining the masters. In FIG. 6, a parent master 160 is represented by a combination of figures indicating indicators of a cellular phone. The figures indicating a received signal strength 162, busy states 164 and 166, an alarm 168, and a short message 170 are child masters of the parent master 160. In this case, some child masters may be generated by combining other masters. As can be seen from FIG. 6, the master (child) 162 indicating the received signal strength is generated by combining an antenna master (grandchild) 172 and a master (grandchild) 174 indicating the strength of a received signal. In this case, the master (child) 162 indicating the received signal strength is a child master of the parent master 160, but may be a parent master of the antenna master (grandchild) 172 and the master (grandchild) 174 indicating the strength of a received signal. In this way, when the simplest child masters are formed, it is possible to generate a new master by combining the simplest child masters. Therefore, the masters are formed in a hierarchy structure.

As shown in FIG. 5, the masters are shown in the form of a tree structure in the master structure view area 130 such that the user can intuitively grasp the hierarchy structure of the masters easier. In FIG. 5, an indicator 132 represents a parent master, and components 134 constituting the tree indicate child masters. When each node is selected from the tree, the child masters constituting a corresponding master may appear. When a master is selected from the master structure view area 130, the selected master 132 may be shown in a preview area 138. When the masters are reconstituted through several stages, the relationship among the masters may become very complicated. The user can directly check the structure of the masters in the master structure view area 130 and directly edit a master while viewing the tree structure without finding the corresponding master in the master area 110. When the user wants to edit a master to change thee master, the user clicks an editing button 135 in the master structure view area 130 to change the master in the master changing area 410. Alternatively, the user may double-click a corresponding master to change the master in the master changing area 410.

According to this exemplary embodiment of the invention, in the hierarchy structure of masters, when the child master is changed, the parent master including the changed child master as well as the instance generated by the child master is changed, and the instances generated by the parent master may be collectively changed. In FIG. 5, when an all-master application 136 is selected and then a child master is selected to be changed, the parent masters related to the child master may also be changed. Of course, when the all-master application 136 is not selected, the parent master including a child master and the instance generated by the parent master may not be changed although the child master is changed. When the child master is changed, the user may select an option to allow the changed child master to have an effect on the parent master in the master structure view area 130 or the master changing area 410, or the user may select another option.

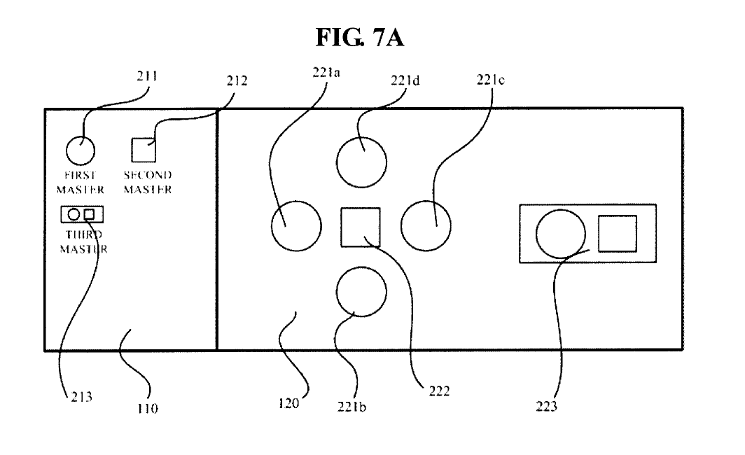

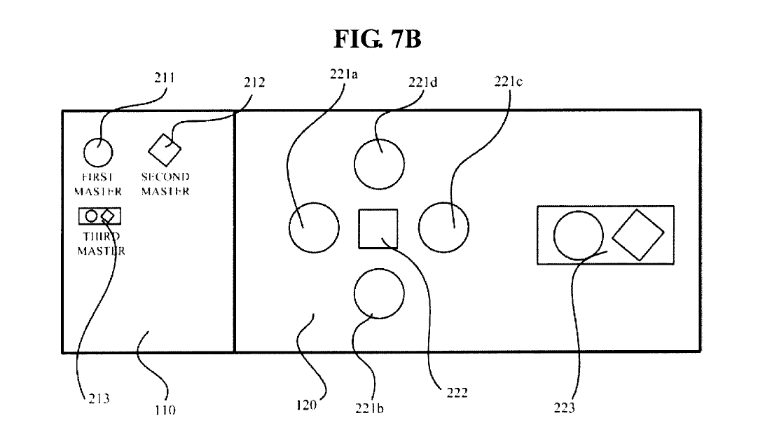

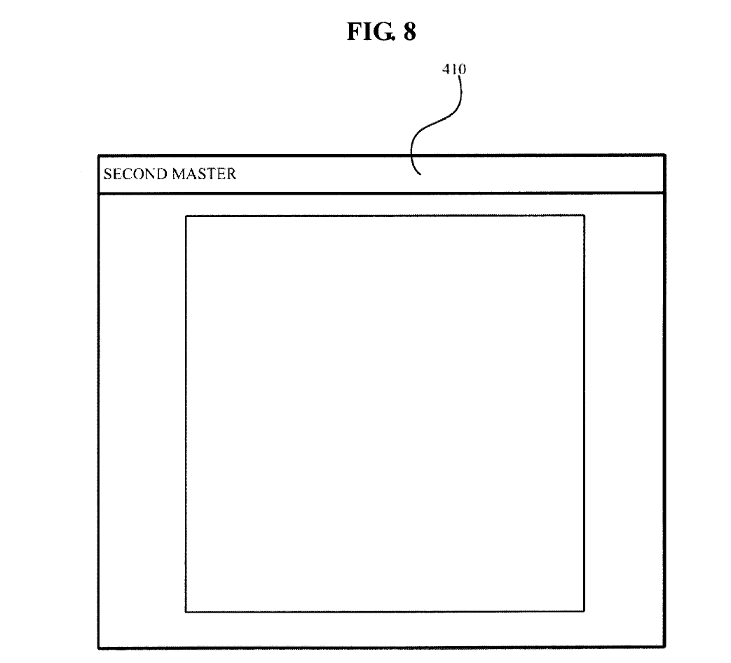

FIGS. 7A and 7B are diagrams illustrating a collective change in parent masters due to a change in a child master in a word processor capable of collectively changing instances using a master according to an exemplary embodiment of the invention, and FIG. 8 is a diagram illustrating a master changing area according to an exemplary embodiment of the invention.

As show in FIG. 7A, a first master 211 having a circular shape, a second master 212 having a rectangular shape, and a third master 213 generated by combining the first master 211 and the second master 212 are formed in the master area 110. As can be seen from FIG. 7A, an instance 222 copied from the second master 212 is formed in the text editing area 120, and circular instances 221a, 221b, 221c, and 221d copied from the first master 211 are formed around the instance 222. Also, an instance 223 copied from the third master 213 is formed in the text editing area 120. When the user selects a master in the master area 110 or the master structure view area 130, the master changing area 410 shown in FIG. 8 appears. In FIGS. 7A and 7B, the second master 212 will be selected and changed.

Only the master separately selected from the content of the text editing area 120 may be shown in the master changing area 410, and the master may be changed by using all functions of the word processor according to the exemplary embodiment of the invention. When the master is changed in the master changing area 410, the changed content is applied to the instances copied from the master as well as the master. When the all-master application 136 is selected, the parent master including the changed master and instances generated by the parent master are changed.

As shown in FIG. 7B, when the shape of the second master 212 is changed to a diamond shape, the second master 212 in the master area 110 is also changed to a diamond shape. As can be seen from FIG. 7B, the instance 222 formed in the text editing area 120 is also changed to a diamond shape with the change in the shape of the second master 212. In addition, the shape of the third master 213 including the second master 212 is changed to a diamond shape with the change in the shape of the second master 212, and the rectangular shape is also changed to a diamond shape in the instance 223 generated by the third master 213.

If the all-master application 136 is not selected, only the second master 212 and the instance 222 generated by the second master 212 are changed to diamond shapes, but the rectangles in the third master 213 and the instance 223 generated by the third master 213 are not changed to diamond shapes. In this way, when the all-master application 136 is not selected in changing the child master, inconsistency may occur between the parent master and the child master. That is, in a case in which the third master 213 is a parent master including the second master 212, when the second master 212 is changed, the third master 213 is not changed, which may result in inconsistency between the parent master and the child master. In this exemplary embodiment of the invention, the temporal inconsistency therebetween intentionally occurs to provide the user with the sufficient degree of freedom in editing text. Even when the inconsistency exists therebetween, the parent and child masters in the hierarchy structure and the instances generated by the masters can be changed by selecting the all-master application 136 and changing the child master, which makes it possible to match the parent master with the child master. In this way, it is possible to provide the user with a function of editing text with the degree of freedom, and to collectively change the instances again since the link relationship between the instances remains without any changes from the viewpoint of an internal structure.

Next, a graphic user interface capable of selectively changing instances using a master according to another exemplary embodiment of the invention will be described.

The graphic user interface capable of selectively changing instances using a master may include a master area 110, a text editing area 120, and a master structure view area 130, similar to the graphic user interface capable of collectively changing instances using a master, and thus a detailed description of the areas will be omitted.

According to this exemplary embodiment of the invention, the instances linked by the master are collectively changed when the master is changed, but the instances are selectively changed. When a user draws up a document, in some cases, the user should not collectively change the instances. That is, in a case in which ten instances are copied from a master, when the master is changed, one of the ten instances may not be changed.

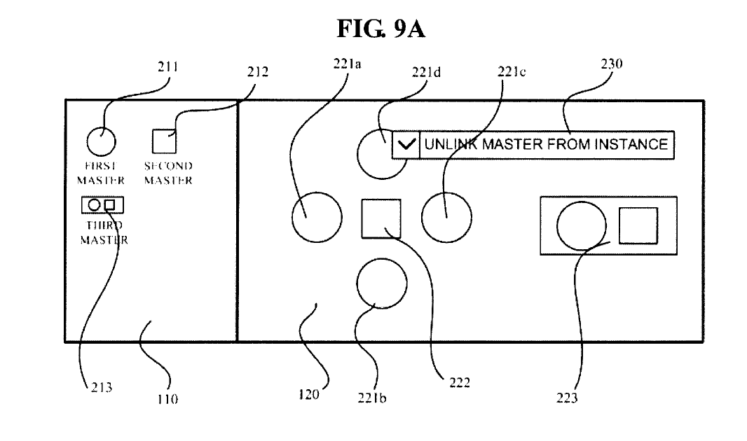

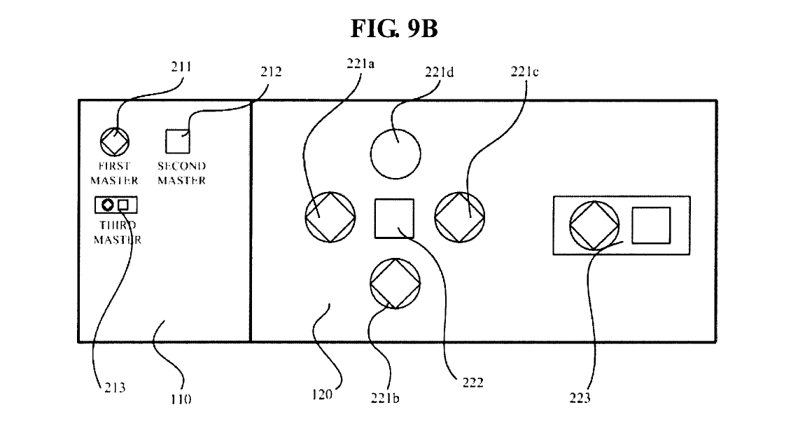

FIGS. 9A and 9B show a case in which masters are unlinked from instances and the instances are selectively changed when the masters are changed in a word processor capable of selectively changing the instances using the masters according to an exemplary embodiment of the invention.

As can be seen from FIG. 9A, as described with reference to FIGS. 7A and 7B, the first master 211, the second master 212, and the third master 213 are generated in the master area 110, and instances 221a to 221d, 222, and 223 copied from the masters are generated in the text editing area 120.

The following method may be used as a method of unlinking the masters from the instances: as shown in FIG. 9A, when the user selects an instance 221d to be unlinked in the text editing area 120 (for example, the user clicks a right button of a mouse), a menu to unlink the master from the instances appears and the user uses the menu to unlink the master from the instances.

In this way, when the user independently unlinks the master from the instance to change the master, the instance unlinked from the master is not changed even when the master is changed, and the other masters are collectively changed. In FIG. 9A, among the instances that are generated by the first master and arranged in a diamond shape, the first master 211 is unlinked from the instance 221 located at the upper side of the diamond, and the master changing area 410 is executed to change the first circular master 211 such that a diamond shape is added to the inside of the circle. Then, as shown in FIG. 9B, the first master 211 is changed in the master area 110, and the instances 221a, 221b, and 221c generated by the first master 211 are changed. However, the instance 221d unlinked from the first master 211 is not changed. When the all-master application 136 is selected, the first master 1 is changed, which causes the third master 213, which is a parent master, and the instance 223 generated by the third master 213 to be changed, as described above.

Further, as described above, since the invention supplies the hierarchy structure of masters, it is possible to unlink a parent master from a child master in the hierarchy structure. The tree structure between the parent master and the child master may be broken in the master structure view area 130, thereby unlinking the parent master from the child master. In this way, when the child master is unlinked from the parent master, the instances generated by the parent master may not be changed although the child master is changed. In this case, it is possible to temporarily remove a connection line from the hierarchy structure tree, and to delete the corresponding master to reconstitute the hierarchy structure of the masters.

Furthermore, the graphic user interface may give a user to a dialogue box inquiring whether to change each instance after the master is changed in the master changing area 410. In this case, when the user selects “no change”, the graphic user interface may automatically unlink the master from the instance.

Next, the method of collectively changing instances using a master and the method of selectively changing instances using a master according to the exemplary embodiments of the invention will be described.

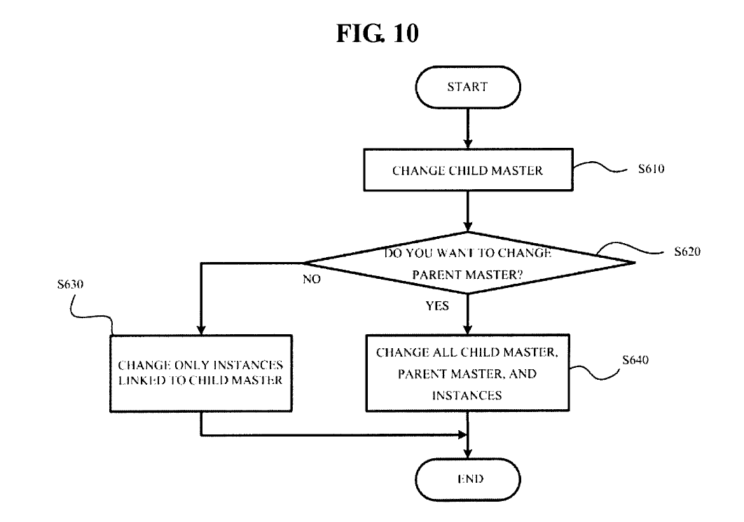

FIG. 10 is a flow chart illustrating the method of collectively changing instances using a master according to the exemplary embodiment of the invention.

In a word processor including a master window 110 and a text editing window 120, when the master window 110 is formed in a hierarchy structure of child masters and a parent master, a specific child master is changed (S610). A corresponding master may be selected in the master window 110 or the master may be selected from a tree structure of a master structure view window 130 to generate a master changing window 410, and the selected master may be changed.

Then, the child master is changed, and is the user selects whether to change the parent master including the child master (S620). Whether to change the parent master may be selected in the master structure view window 130 or in the master changing window 410. Alternatively, the user may select a separate option menu to change the parent master.

When the user selects to change the parent master with a change in the child master, the child master, the parent master, and the instances generated by the masters are collectively changed (S640). On the other hand, when the user selects “no change”, only the child master and the instances generated by the child master are changed, but the parent master is not changed (S630).

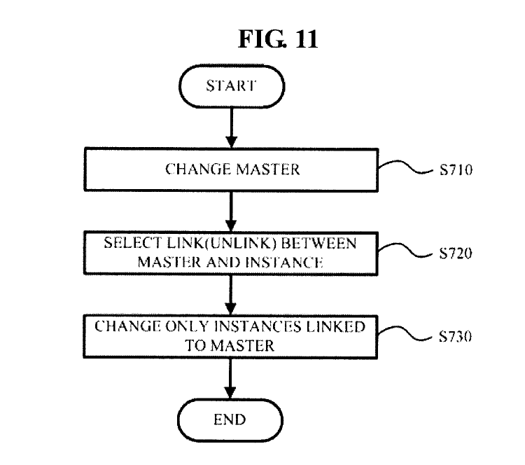

FIG. 11 is a flow chart illustrating the method of selectively changing instances using a master according to the exemplary embodiment of the invention.

In a word processor including the master window 110 and the text editing window 120, when instances are copied to the text editing window 120 by masters and linked to the masters, first, a specific child master is changed (S710). A method of changing the master has been described above, and thus a description thereof will be omitted.

Then, the master is unlinked from the instances such that all the instances are not changed due to a change in the master (S720). It is possible to select each instance to select whether to independently unlink the master from the instances. Further, the parent master may be unlinked from the child master in a tree structure of the masters in the master structure view window 130 such that the parent master is not changed although the child master is changed.

Subsequently, whether to change the instances is set and then the master change is executed. Then, the instances unlinked from the master are not changed, but the instances linked to the master are changed when the master is changed (S730).

Although the present invention has been described in connection with the exemplary embodiments of the present invention, it will be apparent to those skilled in the art that various modifications and changes of the invention may be made without departing from the scope and spirit of the invention. Therefore, it should be understood that the above exemplary embodiments are not limitative, but illustrative in all aspects.

As described above, according to the word processor capable of collectively or selectively changing instances using a master and the method of collectively or selectively changing instances using a master according to the invention, the following effects may be obtained.

First, it is possible to collectively change an object, such as a figure, a picture, or a photograph, other than a character string. In addition, it is unnecessary to separately change a parent master although a child master is changed, and when the child master is changed, the parent master including the changed child master can also be changed.

Second, it is possible to separately control the link relationship between masters and instances and thus to ensure the degree of freedom in drawing up documents.

What is claimed is:

1. A graphic user interface capable of collectively changing instances using a master, the graphic user interface comprising:
a master area having masters, which are objects to be copied, defined therein; and
a text editing area which is capable of copying the master to draw up a document,
wherein the master area is formed in a hierarchy structure of child masters and a parent master made by combining the child masters, and
wherein if a specific child master in the master area is changed, the child masters constituting the parent master that comprises the specific child master are changed, and the child masters before the change and instances linked to the text editing area by the parent master are all changed.

2. The graphic user interface of claim 1, further comprising:
a master structure view area which shows the hierarchy structure of the child masters and the parent master in a tree structure.

3. The graphic user interface of claim 2, wherein, if a specific master is selected in the master structure view area, the master structure view area forms a master changing area used to change the selected master.

4. The graphic user interface of claim 3, wherein, if the specific child master is changed, the master structure view area or the master changing area is selected such that the child masters constituting the parent master that comprises the specific child master and the instances linked to the text editing area by the parent master are not changed.

5. A graphic user interface capable of selectively changing instances using a master, the graphic user interface comprising:
a master area having masters, which are objects to be copied, defined therein; and
a text editing area which is capable of drawing up a document and includes instances that are copied from the masters and linked to the masters,
wherein, if the master in the master area is changed, the instances are selectively changed.

6. The graphic user interface of claim 5, wherein the instances are individually unlinked from the masters such that the instances are not changed although the masters are changed.

7. The graphic user interface of claim 5, further comprising:
a master structure view area which shows a hierarchy structure of the master area having child masters and a parent master made by combining the child masters in a tree structure.

8. The graphic user interface of claim 7, wherein the parent master is unlinked from the child masters in the tree structure of the master structure view area so that, although the child master is changed, the instances linked to the text editing area by the parent master are not changed.

9. The graphic user interface of claim 7, wherein, if a specific master is selected in the master structure view area, the master structure view area forms a master changing area for changing the selected master.

10. A method of collectively changing instances using a master in a word processor comprising a master window having masters, which are objects to be copied, defined therein and a text editing window copying the masters to draw up a document, the master window being formed in a hierarchy structure of child masters and a parent master made by combining the child masters, the method comprising:
changing a specific child master in the master window;
selecting whether to change the child masters constituting the parent master that comprises the specific child master;
if it is selected to change the child masters, the child masters constituting the parent master are changed, and the child masters before the change and instances generated by the parent masters are all changed; and
if it is selected not to change the child masters, only instances generated by the child masters before the change are changed.

11. The method of claim 10, wherein the word process further comprises a master structure view window which shows the hierarchy structure of the child masters and the parent master in a tree structure.

12. The method of claim 11, wherein, if a specific master is selected in the master structure view window, the master structure view window forms a master changing window for changing the selected master.

13. The method of claim 12, wherein one of the master structure view window and the master changing window is selected such that, if the specific child master is changed, the child masters constituting the parent master that includes the specific child master and instances linked to the text editing window by the parent master are not changed.

14. A method of selectively changing instances using a master in a word processor comprising a master window having masters, which are objects to be copied, defined therein and a text editing window capable of drawing up a document and including the instances that are copied from the masters and are linked to the masters, the method comprising:
changing a specific master in the master window;
selecting an instance not to be changed among instances linked to the specific master; and
changing only instances other than the selected instance.

15. The method of claim 14, wherein the instances are individually unlinked from the masters such that the instances are not changed although the masters are changed.

16. The method of claim 14, wherein the word processor further comprises a master structure view window which shows the hierarchy structure of the master window having child masters and a parent master made by combining the child masters in a tree structure.

17. The method of claim 16, wherein the parent master is unlinked from the child masters in the tree structure of the master structure view window so that, although the child master is changed, the instances linked to the text editing window by the parent master are not changed.

18. The method of claim 16, wherein, if a specific master is selected in the master structure view window, the master structure view window forms a master changing window for changing the selected master.
